(19) United States
(12) Patent Application Publication
(10) Pub. No.: US 2012/0113745 A1
(43) Pub. Date: May 10, 2012

(54) ACTIVE STEERING CURVED AND FLARED SEISMIC STREAMERS

(75) Inventors: Peter M. Eick, Houston, TX (US); Joel D. Brewer, Houston, TX (US)

(73) Assignee: ConocoPhillips Company, Houston, TX (US)

(21) Appl. No.: 13/289,646

(22) Filed: Nov. 4, 2011

Related U.S. Application Data
(60) Provisional application No. 61/410,638, filed on Nov. 5, 2010.

(51) Int. Cl. G01V 1/38

(52) U.S. Cl. 367/16

(57) ABSTRACT

The invention relates to seismic data acquisition in a marine environment with long streamers of hydrophone receivers towed by a boat. In the present invention, the streamers are steered to follow a course that is related to the navigated path of the boat. Hydrophones at the far ends of the long streamers are arranged to follow a course even though the boat may have made a significant turn that would otherwise pull the streamers off the desired course. Using this invention, seismic acquisition is more efficient by allowing the vessel to spend less time outside the survey area and making tighter turns to get back on productive seismic data acquisition.

### CROSS-REFERENCE TO RELATED APPLICATIONS

This application is a non-provisional application which claims benefit under 35 USC §119(e) to U.S. Provisional Application Ser. No. 61/410,638 filed Nov. 5, 2010 entitled “Active Steering Curved and Flared Seismic Streamers”, which is incorporated herein in its entirety.

### STATEMENT REGARDING FEDERALLY SPONSORED RESEARCH OR DEVELOPMENT

None.

### FIELD OF THE INVENTION

This invention relates generally to seismic data acquisition in marine environments using towed streamers behind a tow vessel.

### BACKGROUND OF THE INVENTION

Marine seismic exploration is used to investigate and map the structures and character of subsurface geological formations underlying a body of water. Marine seismic data is typically gathered by towing seismic sources (e.g., air guns) and seismic receivers (e.g., hydrophones) through a body of water behind one or more marine vessels. As the seismic sources and receivers are towed through the water, the seismic sources generate acoustic pulses that travel through the water and into the earth, where they are reflected and/or refracted by interfaces between subsurface geological formations. The seismic receivers sense the resulting reflected and/or refracted energy, thereby acquiring seismic data that provides information about the geological formations underlying the body of water. Basically a towed seismic source emits a wavefield that propagates down through the water and into earth and is reflected and/or refracted by interfaces between subsurface geological formations then propagates back to the surface where the receivers detect and discretely sample the wavefield.

Typically, an array of thousands of individual seismic receivers is used to gather marine seismic data. The seismic receivers are generally uniformly spaced and attached to streamer cables that are towed behind the marine vessel. It is known that the relative positions of the marine seismic receivers during seismic data acquisition can affect the quality and utility of the resulting seismic data. The current teaching is to construct the towing configuration for the streamers such that the ends of the streamers nearest the towing vessel, (commonly known as “near receivers” or “head of the streamers” or “leading end”) are all laterally spaced at equal distance along the length of the streamers. Typically contracts require that the streamers be maintained equally spaced to within 2% of nominal at the head of the streamers or the towing configuration must be adjusted to get “in spec”. In this configuration, uniform coverage of the surface and subsurface is achieved by at least the near receivers. It is known that the wavefield detected by the sensors is poorly sampled in the lateral direction (perpendicular to the streamers) in most streamer configurations because wider spacing size is necessary to make the cost of the survey affordable and to avoid tangles of the equipment behind the boat. Normally the spacing between streamers is substantially wider than the station spacing down the length of streamer and typically varies from between 4 and 32 to 1. Thus, for example, the normal station spacing along the streamer is usually 12.5 meters between hydrophones while the spacing between two adjacent streamers may be 100 meters, to create a ratio of 8 to 1. Common station spacing range down to 3.125 meters and streamer spacing can be as near as 37.5 meters. Thus, if the spacing of the streamers at the head of the streamers is large, the wavefield detected by the receivers is highly under sampled in the lateral direction relative to the sampling along or down the streamer. For clarity, “lateral” is meant to describe perpendicular to the length of the streamer.

However, unpredictable environmental forces such as currents, winds, and seas present in many marine environments can cause the relative positions of marine seismic receivers to vary greatly as they are towed through the water. Therefore, it is becoming common to use steering devices (known as “birds”) to be attached to the streamer cables so that the relative positions (both lateral and vertical) of the seismic receivers can be controlled as they are towed through the water. The control of the streamer positions in the lateral direction down the streamer currently helps to maintain desired spacing between streamers, but provides for new opportunities to shape the streamers to enhance the data collected in a marine survey.

### BRIEF SUMMARY OF THE DISCLOSURE

The invention more particularly relates to a process for acquiring seismic data in a marine environment using seismic receivers mounted to streamers in the water following behind a tow vessel. The process more particularly includes installing a series of guidance devices along the length of each streamer with a steerable element providing lateral streamer control. The tow vessel is directed to follow a path through the water where the path that the tow vessel has taken is a navigated path and where the navigated path includes turns; and the guidance devices are countersteered to cause the streamers to maintain an arcuate shape around a turn and maintaining the path of the streamers to follow the tow vessel navigated path.

### BRIEF DESCRIPTION OF THE DRAWINGS

A more complete understanding of the present invention and benefits thereof may be acquired by referring to the follow description taken in conjunction with the accompanying drawings in which:

FIG. 1 is top view of a marine seismic system including a tow vessel towing streamers, only two of which are shown, to illustrate the features of the present invention; and

FIG. 2 is top view of a second orientation of the streamers of a marine seismic system where the features of the present invention may be recognized and appreciated.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

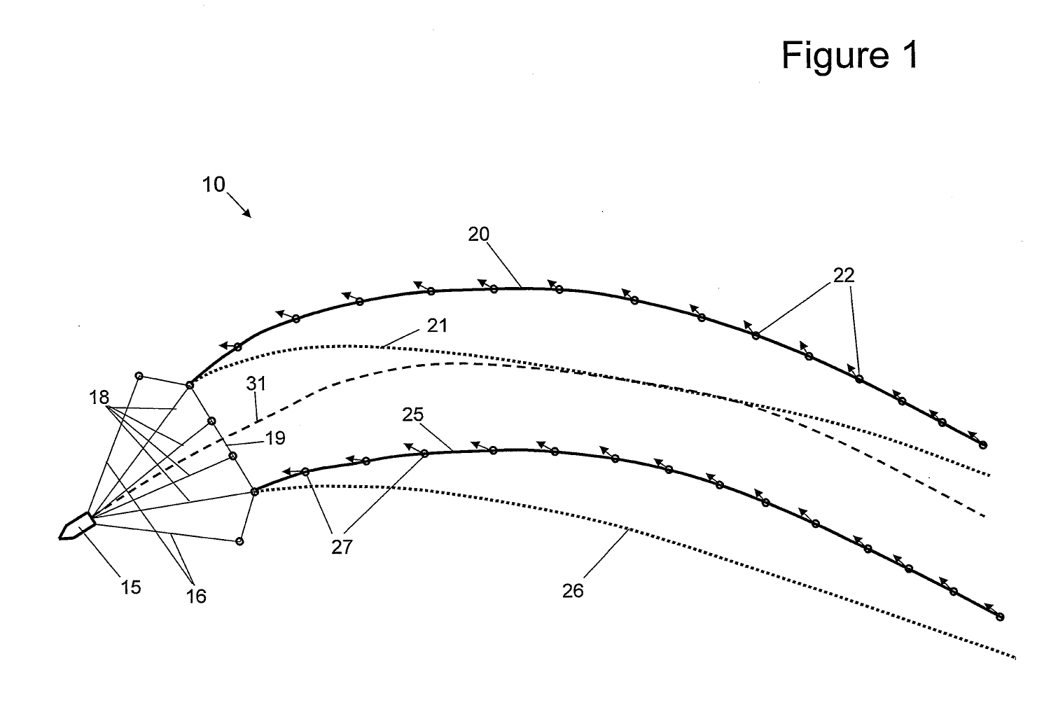

As shown in FIG. 1, a marine seismic data acquisition system of the present invention is generally indicated by the arrow 10. The system 10 includes a tow vessel 15 that is shown making a broad turn to its left. Trailing behind the tow vessel 15 is a series of streamers where only the two outside streamers 20 and 25 are shown for simplicity of illustration. In particular, the streamers 20 and 25 are shown to be following the true path of the vessel or the navigated path 31. In a conventional arrangement, the streamers 20 and 25 would be pulled laterally by the cable tension away from a path that follows the navigated path into shapes shown in dotted lines 21 and 26. These shapes 21 and 26 reflect paths where the streamers have cut the corner across a large round turn and where the streamers have literally been dragged laterally off the navigate path 31. In the present invention, the lateral forces on the streamers 20 and 25 are still present, however, the birds 22 on streamer 20 and birds 27 on streams 25 are operated to resist and counteract the lateral dragging forces created by a turning vessel.

Each of the streamers is connected to the tow vessel 15 by tow lines 18 and a lateral guide line 19 is used to maintain the leading end of the streamers to be a design separation distance. Outrigger lines 16 and outrigger water wings, mini-wings, paravanes or “doors” 17 are used to draw the guide line 19 relatively taught and thereby pull the leading ends of the streamers to their design spacing.

The counteracting steering of each bird 22 and 27 is shown by arrows at the birds which includes vanes or other hydrofoil shape that can steer itself in the water using the forward movement of the streamer. The amount of counteractive steering force exerted by each of the birds 22 and 27 is not significant, but as FIG. 1 suggests, the far ends of the streamers will follow a significantly different path as the streamer undertakes a more accurate shape through the turns. Each of the birds 22 and 27 are arranged to use a GPS input from the streamer and acoustic images for their own location and are operated to steer relative to the navigated path 31 of the vessel 15. The computational activity may take place within the birds themselves or simply provided by communication from a central navigation processing capability on the vessel 15 or from another location.

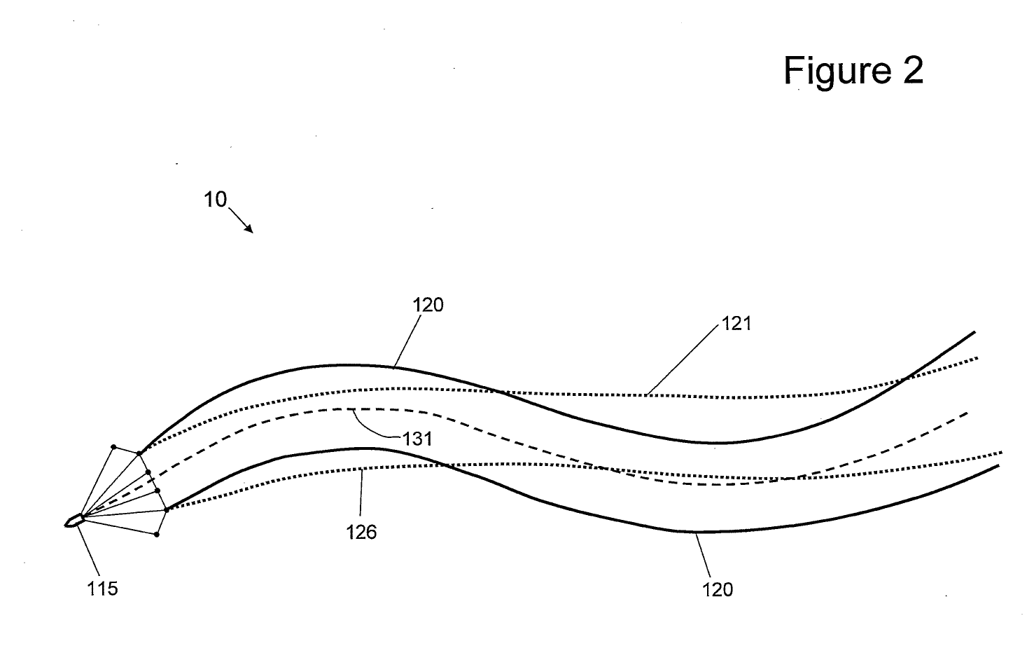

Turning to FIG. 2, the benefits of the present invention may be more helpful when the vessel 115 takes a more complicated path and the streamers 120 and 125 are in a flared streamer configuration so are subjected to significant tension causing the streamers to “want” to assume a more linear shape as shown by dotted lines 121 and 126. In the present invention, the arcuate or “S” shape is preferred wherein the streamers are maintaining greater fidelity to the navigated path 131 of the vessel 115. Note that the birds 122 and 127 within the first half of the streamers 120 and 125 are counteracting a turn to the left by exerting a pull to the right while the birds at the latter half of the streamers 120 and 125 are, at the very same time, counteracting a turn to the right by exerting a pull to the left. The flared streamer configuration has the streamer separation at the head of the streamer being smaller than the streamer separation at the tail of the streamer. The birds used to control the lateral streamer separation actively steer to maintain this configuration while concurrently steering so that the streamers' 120 and 125 path mimics the vessel 115 path. In addition to guiding the streamers along the arcuate shaped path relative to the navigated path, the streamers are also flared such that the spacing of the streamers at the ends nearest the vessel 15 are closer together then they are at the far ends. Having the streamers spaced farther from one another provides greater certainty of coverage with the far receivers. It is not uncommon because of currents in the sea that gaps between adjacent passes of the streamers are created, especially at the far ends which are most subject to currents. Having the streamers flared reduces the likelihood of gaps. In the preferred embodiment, the outside streamers are flared the most and are at least five percent wider at the far end as compared to the near end or end nearest the tow vessel 15. In some circumstance, the flaring may preferably be ten percent, 15 percent, 20 percent, 25 percent, 30 percent, 40 percent and even at least 50 percent greater at the far end as compared to the spacing at the near end.

It should be noted that in conventional seismic acquisition, the tow vessel 15 typically tows a relatively straight line path through a survey area in a near uniform streamer separation configuration and then makes broad turns outside the survey area so that all of the issues associated with long streamers are sorted out prior to re-entering the survey area for further surveying. Seismic acquisition is not typically taken during turns. To the extent that turns are performed while actively taking seismic data, the birds are used to maintain the spread of the streamers and not countersteer the streamers to maintain fidelity to the navigated path of the vessel and a flared streamer configuration.

Typically, at least four streamers are used and it is more common to have 6, 8, 10 or 12 streamers. Only two outside streamers are shown for simplicity.

As noted above, in a preferred embodiment of the present invention, the counteractive steering is coupled with a flared streamer arrangement as described in U.S. patent application Ser. No. 12/167,683 filed Jul. 3, 2008. In addition, an arrangement with four or more streamers may have the streamers unequally spaced as shown in U.S. Patent Application 61/353,089, filed Jun. 9, 2010, which is incorporated by reference herein. When the vessel is steered in a curved path the streamers are actively steered by birds that control the lateral streamer separation so that the path of the streamers mimics the path of the vessel and the streamer separation is maintained.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for acquiring seismic data in a marine environment using seismic receivers mounted to streamers in the water following behind a tow vessel, the process comprising:
a) installing a series of guidance devices along the length of each streamer with a steerable element providing lateral streamer control;
b) directing the tow vessel to follow a path through the water where the path that the tow vessel has taken is a navigated path and where the navigated path includes turns; and
c) countersteering the guidance devices to cause the streamers to maintain an arcuate shape around a turn and maintaining the path of the streamers to follow the tow vessel navigated path.

2. The process according to claim 1 wherein each guidance device uses its steerable element to exert a force to steer itself along a path relative to the navigated path and wherein the forces exerted vary over time and concurrently different forces between guidance devices.

3. The process according to claim 1 wherein each guidance device uses its steerable element hydrofoil to exert a force to steer itself along a path relative to the navigated path and wherein the forces exerted vary over time and concurrently different forces between guidance devices and the streamers are towed in flared configuration such that the separation between the streamers at the head of the streamers is smaller than the separation between the streamers at the tail of the streamers.

4. The process according to claim 3 wherein the flaring of the streamers is at least five percent greater at the far ends of the streamers as compared to the near ends of the streamer or the ends closest to the tow vessel.

5. The process according to claim 3 wherein the flaring of the streamers is at least ten percent greater at the far ends of the streamers as compared to the near ends of the streamer or the ends closest to the tow vessel.

6. The process according to claim 3 wherein the flaring of the streamers is at least fifteen percent greater at the far ends of the streamers as compared to the near ends of the streamer or the ends closest to the tow vessel.

7. The process according to claim 3 wherein the flaring of the streamers is at least twenty percent greater at the far ends of the streamers as compared to the near ends of the streamer or the ends closest to the tow vessel.

8. The process according to claim 3 wherein the flaring of the streamers is at least twenty five percent greater at the far ends of the streamers as compared to the near ends of the streamer or the ends closest to the tow vessel.

9. The process according to claim 3 wherein the flaring of the streamers is at least thirty percent greater at the far ends of the streamers as compared to the near ends of the streamer or the ends closest to the tow vessel.

10. The process according to claim 3 wherein the flaring of the streamers is at least forty percent greater at the far ends of the streamers as compared to the near ends of the streamer or the ends closest to the tow vessel.

11. The process according to claim 3 wherein the flaring of the streamers is at least fifty percent greater at the far ends of the streamers as compared to the near ends of the streamer or the ends closest to the tow vessel.
